(19) United States
(12) Patent Application Publication
(10) Pub. No.: US 2023/0086337 A1
(43) Pub. Date: Mar. 23, 2023

(54) METHODS, INFRASTRUCTURE EQUIPMENT AND WIRELESS COMMUNICATIONS NETWORKS

(71) Applicant: Sony Group Corporation, Tokyo (JP)

(72) Inventors: Vivek SHARMA, Basingstoke (GB); Yuxin WEI, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 17/798,889

(22) PCT Filed: Mar. 12, 2021
(86) PCT No.: PCT/EP2021/056346

§ 371 Date: Aug. 11, 2022

(30) Foreign Application Priority Data
Mar. 31, 2020 (EP) 20167440.5

(51) Int. Cl. H04W 40/24; H04W 8/00; H04W 36/08

(52) U.S. Cl. CPC H04W 40/248; H04W 8/005; H04W 36/08

(57) ABSTRACT

A communications device acts as a remote (first) communications device and communicates via another (second) communications device acting as a relay. The remote communications device communicates, via a wireless communications network using a first wireless access interface implemented by a first set of protocol entities in the remote communications device and a corresponding first set of peer protocol entities. The remote communications device receives an indication of a configuration of a second wireless access interface for communication between the remote communications device and the relay communications device, the first wireless access interface being implemented by a second set of protocol entities in the remote communications device and a corresponding second set of peer protocol entities in the relay communications device. The remote communications device maintains at least one of the first set of protocol entities in the remote communications device.

### BACKGROUND

### Field of Disclosure

The present disclosure relates to methods and apparatus for the communication of signals between various infrastructure equipment, communications devices and the core network in a wireless communications system.

The present disclosure claims the Paris convention priority to European patent application number 20167440.5, the contents of which are incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Recent generation mobile telecommunication systems, such as those based on the 3GPP defined UMTS and Long Term Evolution (LTE) architectures, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. In addition to supporting these kinds of more sophisticated services and devices, it is also proposed for newer generation mobile telecommunication systems to support less complex services and devices which make use of the reliable and wide ranging coverage of newer generation mobile telecommunication systems without necessarily needing to rely on the high data rates available in such systems. The demand to deploy such networks is therefore strong and the coverage area of these networks, i.e. geographic locations where access to the networks is possible, may be expected to increase ever more rapidly.

Future wireless communications networks will therefore be expected to routinely and efficiently support communications with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

The demand to deploy fifth generation networks is therefore strong and the coverage area of these networks, i.e. geographic locations where access to the networks is possible, is expected to increase rapidly. However, although the coverage and capacity of fifth generation networks is expected to significantly exceed those of previous generations of communications networks, there are still limitations on network capacity and the geographical areas that can be served by such networks. These limitations may, for example, be particularly relevant in situations in which there is a desire for a group of terminal devices (communications devices) to exchange information with each other in a fast and reliable manner In order to help address these limitations there have been proposed approaches in which terminal devices within a wireless telecommunications system may be configured to communicate data directly with one another without some or all their communications passing through an infrastructure equipment element, such as a base station. Such communications are commonly referred to generally as a device-to-device (D2D) communications. Many device-to-device communications may be transmitted by one device to a plurality of other devices in a broadcast like manner and so in that sense the phrase “device-to-device communications” also covers “device-to-devices communications”.

Thus, D2D communications allow communications devices that are in sufficiently close proximity to directly communicate with each other, both when within the coverage area of a network and when outside a network's coverage area (e.g. due to geographic restrictions on a network's extent or because the network has failed or is in effect unavailable to a terminal device because the network is overloaded). D2D communications can allow user data to be more efficiently and quickly communicated between communications devices by obviating the need for user data to be relayed by a network entity such as a base station. D2D communications also allow communications devices to communicate with one another even when one or both devices may not be within the reliable coverage area of a network. The ability for communications devices to operate both inside and outside of coverage areas makes wireless telecommunications systems that incorporate D2D capabilities well suited to applications such as public protection/safety and disaster relief (PPDR), for example, PPDR related communications may benefit from a high degree of robustness whereby devices can continue to communicate with one another in congested networks and when outside a coverage area. 3GPP has developed some proposals for such public safety D2D use in LTE networks in Release12.

Providing improvements in reliability and efficiency to extend communications to D2D communications can provide technical challenges.

### SUMMARY OF THE DISCLOSURE

The present disclosure can help address or mitigate at least some of the issues discussed above as defined in the appended claims.

Embodiments of the present technique can provide a method of operating a first communications device forming part of a wireless communications network comprising a second communications device and an infrastructure equipment. The first communications device communicates, via the infrastructure equipment using a first wireless access interface implemented by a first set of protocol entities in the first communications device and a corresponding first set of peer protocol entities in the infrastructure equipment. The first communications device receives, from the infrastructure equipment, an indication of a configuration of a second wireless access interface for communication between the first communications device and the second communications device, the second wireless access interface being implemented by a second set of protocol entities in the first communications device and a corresponding second set of peer protocol entities in the second communications device. The first communications device maintains at least one of the first set of protocol entities in the first communications device. The first communications device configures, on a basis of the indication of the configuration of the second wireless access interface received from the infrastructure equipment, the second wireless access interface for communication between the first communications device and the second communications device. The first communications device processes data using either at least one of the maintained protocol entities of the first set of protocol entities in the first communications device if the data is intended for the infrastructure equipment, or at least one of the second set of protocol entities in the first communications device if the data is intended for the second communications device to facilitate routing of the data between the first communications device, the second communications device and the infrastructure equipment.

Example embodiments can provide a method of communicating by a communications device comprising establishing a packet data connection from the communications device via an infrastructure equipment of a wireless communications network to support a communications session, the connection being formed using a first protocol entity in the communications device via a first wireless communications interface between the communications device and the infrastructure equipment to a peer first protocol entity in the infrastructure equipment. The communications device may then operate to maintain the communications session by establishing a second connection between the communications device and the other communications device acting as a relay node via a second wireless access interface between the communications device and the other communications device acting as a relay node by forming a second protocol entity in the communications device and a peer second protocol entity in the communications device acting as a relay node. The communications device may maintain the communications session by maintaining the first protocol entity for communicating data packets to the peer first protocol entity in the infrastructure equipment, and encapsulating data packets of the first protocol entity as data packets for communication via the second protocol entity to the second peer protocol entity in the other communications device acting as a relay node. Establishing the second protocol entity and a peer protocol entity in the second communications device acting as a relay node can maintain end-to-end encryption and other communications aspects of the communications session even though the communications device is communicating via a relay node.

The development of relay nodes in telecommunications system is expected to facilitate communications with the base stations and potentially to expand the range of coverage of the base stations by relaying communications between terminal devices and base stations. However, due to the complexity of D2D arrangements and in particular to the lack of centralised control points (like the base stations in a conventional mobile network), there is at present a lack of relaying solutions for D2D communications.

Embodiments of the present technique can therefore ensure or improve a likelihood of service continuity when a remote UE switches from communicating with an infrastructure equipment to communicating with a relay UE.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a LTE-type wireless telecommunication system which may be configured to operate in accordance with certain embodiments of the present disclosure;

FIG. 2 schematically represents some aspects of a new radio access technology (RAT) wireless communications system which may be configured to operate in accordance with certain embodiments of the present disclosure;

FIG. 3 is a schematic block diagram of some components of the wireless communications system shown in FIG. 2 in more detail in order to illustrate example embodiments of the present technique;

FIG. 4 schematically represents some aspects of device-to-device (D2D) communications which may be configured to operate in accordance with certain embodiments of the present disclosure.

FIG. 5 is a schematic block diagram of a user plane protocol stack which may be configured to operate in accordance with certain embodiments of the present disclosure.

FIG. 6 is a schematic block diagram of a control plane protocol stack which may be configured to operate in accordance with certain embodiments of the present disclosure

FIG. 7 schematically represents a handover of a first communications device from an infrastructure equipment to a second communications device.

FIGS. 8 and 9 are schematic block diagrams representing a transmission of an RRC message according to example embodiments.

FIGS. 10 and 11 are schematic block diagrams representing a transmission of an RRC message according to example embodiments.

FIGS. 12 and 13 are schematic block diagrams representing a transmission of an RRC message according to example embodiments.

FIG. 14 schematically represents a first communications device establishing a connection with a second communications device after declaring a radio link failure (RLF) for a connection between the first communications device and an infrastructure equipment.

FIG. 15 shows a flow diagram illustrating a process of communications in a communications system in accordance with embodiments of the present technique.

### DETAILED DESCRIPTION OF THE EMBODIMENTS

### Long Term Evolution (LTE) Wireless Communications System

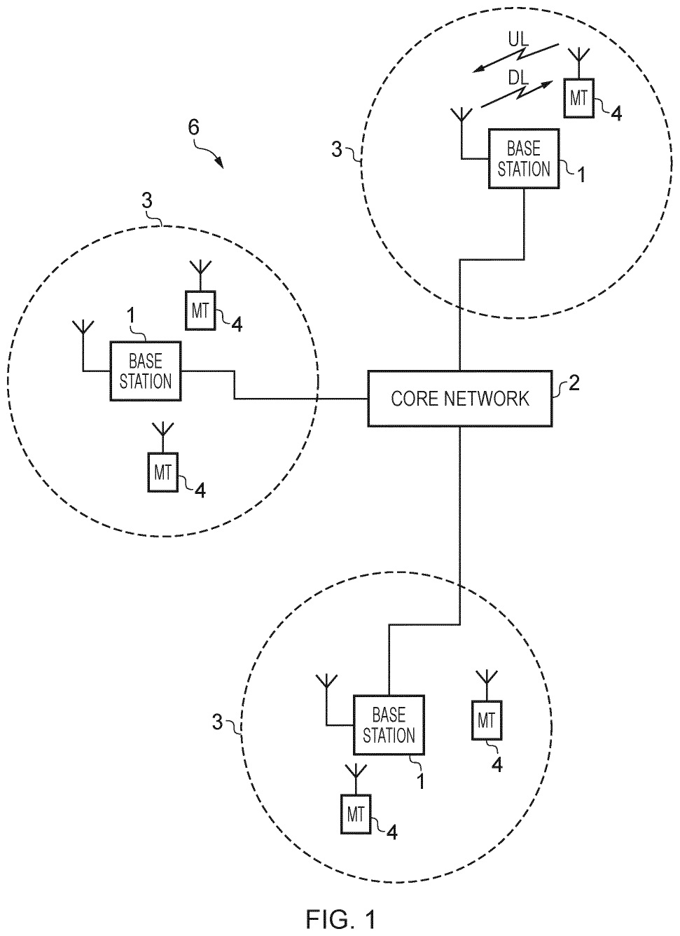

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4.

Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink Data is transmitted from communications devices 4 to the base stations 1 via a radio uplink The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth.

Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G) Wireless Communications System

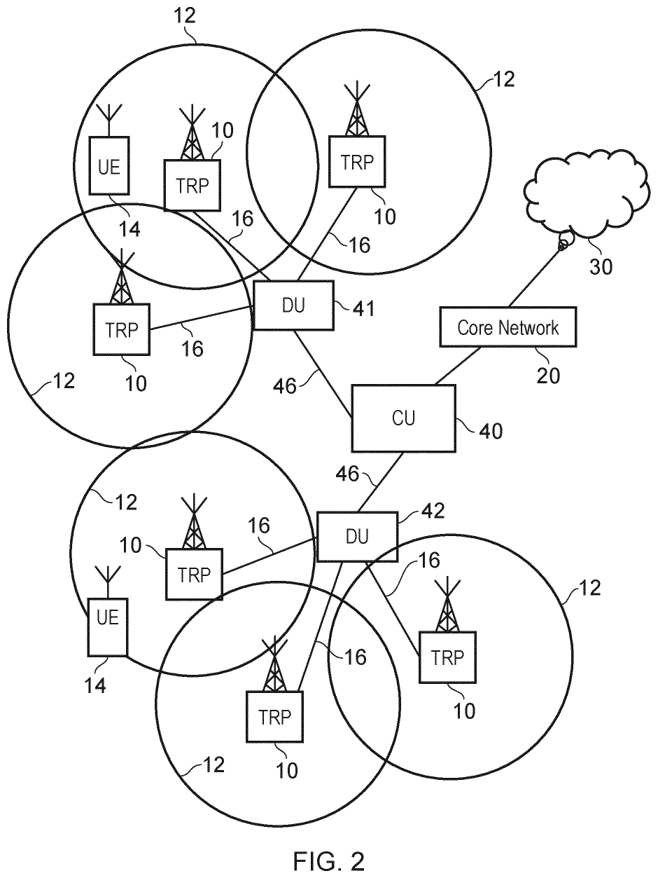

An example configuration of a wireless communications network which uses some of the terminology proposed for NR and 5G is shown in FIG. 2. A 3GPP Study Item (SI) on New Radio Access Technology (NR) has been defined [2]. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the a core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 212 via one of the distributed units 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

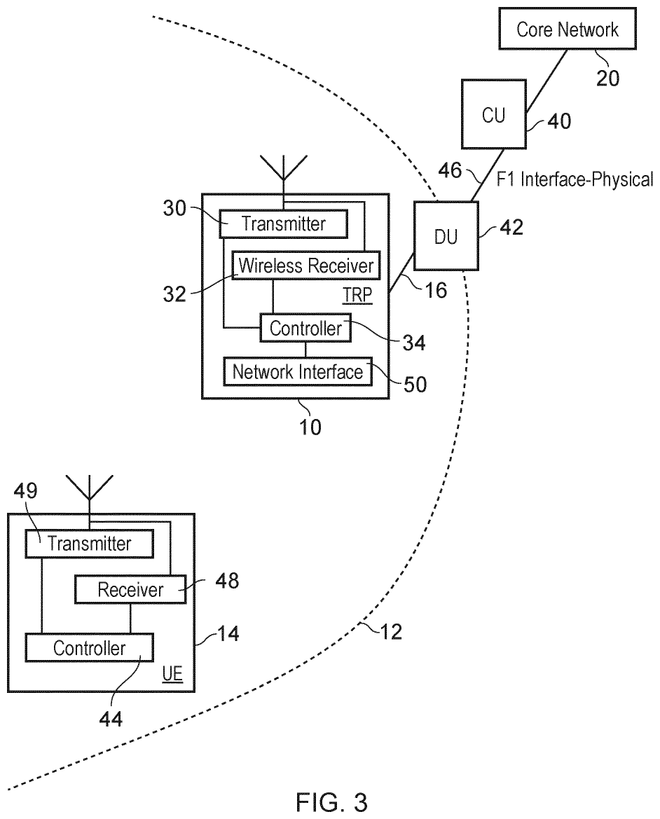

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

Device-to-Device (D2D) and Sidelink Communications

Device-to-Device (D2D) communications is an aspect of mobile communications which has been established for devices to communicate directly with each other rather than via a wireless communications network. That is to say that radio signals representing data are transmitted via a wireless interface by one device and received by another to communicate that data, rather than the signals being transmitted to radio infrastructure equipment of a wireless communication network, which are then detected and decoded by the infrastructure equipment to recover that data and communicated on to a destination device.

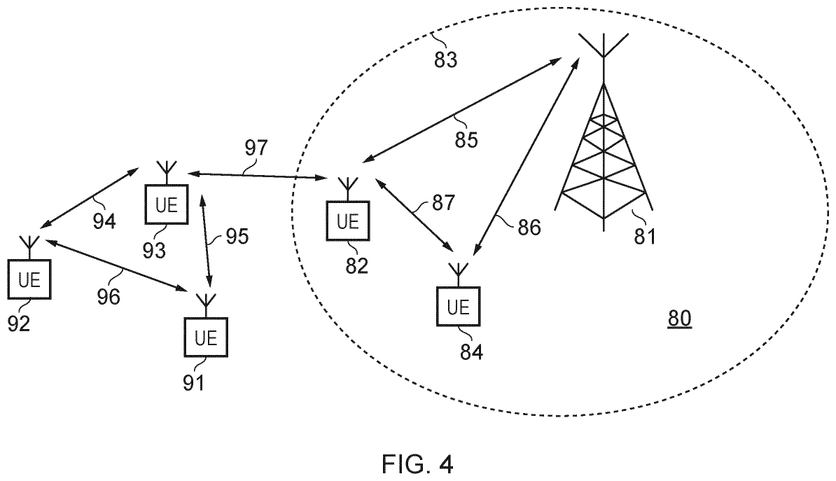

D2D communications can take different forms, which are illustrated in FIG. 4. As shown in FIG. 4, in one example two communications devices (UEs) 82, 84 are operating within a coverage area of a cell 80 provided by radio infrastructure equipment 81, which has a cell boundary 83 represented by a dashed line. The radio infrastructure equipment 81 may for example be a TRP 10 such as that shown in FIG. 2. As represented by double-headed arrows 85, 86, the UEs 82, 84, may transmit and receive signals to the infrastructure equipment 81 to transmit or to receive data on an uplink or a downlink respectively of a wireless access interface formed by a wireless communications network of which the infrastructure equipment 81 forms part. However within the radio coverage area of the cell 80 the UEs 82, 84 may communicate directly between one another via a D2D wireless access interface as represented by a double-headed arrow 87. The UEs 82, 84 can be configured to transmit and to receive signals via a D2D wireless access interface which may be separate and not shared or overlap a frequency band of the wireless access interface provided by the infrastructure equipment 81. Alternatively the UEs 82, 84 may transmit and receive signals via a part of the wireless access interface provided by the infrastructure equipment 81. A D2D wireless access interface formed for one UE to transmit radio signals to another UE is referred to as a sidelink or PC-5.

Another example of D2D communications is also shown in FIG. 4 where UEs fall outside a coverage area of a wireless communication network and so communicate directly with one another. As represented by dashed lines 94, 95, 96, three UEs 91, 92, 93 are operable to transmit and receive signals representing data via sidelinks These sidelinks 94, 95, 96 may be formed by a D2D wireless access interface which falls within a frequency band of the infrastructure equipment 81 or may be outside this frequency band. However the UEs 91, 92, 93 organise access to a D2D wireless access interface autonomously without reference to a wireless access interface. In some cases, the UEs 91, 92, 93 may be pre-configured with some parameters for a D2D wireless access interface. As another example, one of the UEs 82 within the coverage area of the cell 80 acts as a relay node for one or more of the UEs 91, 92, 93 which are outside the coverage area as represented by a sidelink 97.

Here D2D communications of the form of sidelink 87 are referred to as in-coverage communications, D2D communications of the form of sidelink 97 are referred to as partial coverage communications, and D2D communications of the form of sidelinks 94, 95, 96 are referred to as out-of-coverage communications.

According to 3GPP standards such as LTE, whilst downlink and uplink communications are specified for transmissions from an infrastructure equipment such as a gNB to a UE and from a UE to a gNB respectively, sidelink communications are specified to realise UE-to-UE (device-to-device (D2D)) communication, especially for sidelink discovery, sidelink communication and vehicle to everything (V2X) sidelink communication between UEs. The LTE sidelink has the following characteristics as described below, which are reproduced from [3]:
Sidelink comprises sidelink discovery, sidelink communication, and V2X sidelink communication between UEs;
Sidelink uses uplink resources and a physical channel structure similar to uplink transmissions. However, some changes, noted below, are made to the physical channels;
The sidelink/D2D wireless access interface structure includes a physical sidelink control channel (PSCCH) for UEs to transmit control signalling to other UEs and a physical sidelink shared channel (PSSCH) for transmitting data to other UEs. Control messages transmitted on the PSCCH can indicate communications resources of the PSSCH via which the UE will transmit data to another UE. The control message for sidelink is referred to as sidelink control information (SCI). Therefore the PSCCH is mapped to the sidelink control resources and indicates resource and other transmission parameters used by a UE for PSSCH;
Sidelink transmission uses the same basic transmission scheme as the uplink transmission scheme. However, sidelink is limited to single cluster transmissions for all the sidelink physical channels. Furthermore, sidelink uses a one symbol gap at the end of each sidelink sub-frame. For V2X sidelink communication, PSCCH and PSSCH are transmitted in the same subframe;
The sidelink physical layer processing of transport channels differs from uplink transmission in the following steps:
Scrambling: for PSDCH and PSCCH, the scrambling is not UE-specific; and
Modulation: 256 QAM is not supported for sidelink 64 QAM is only supported for V2X sidelink communication;
For PSDCH (physical sidelink discovery channel), PSCCH and PSSCH demodulation, reference signals similar to uplink demodulation reference signals are transmitted in the fourth symbol of the slot in normal cyclic prefix (CP) and in the third symbol of the slot in extended cyclic prefix. The sidelink demodulation reference signals sequence length equals the size (number of sub-carriers) of the assigned resource. For V2X sidelink communication, reference signals are transmitted in the third and sixth symbols of the first slot and the second and fifth symbols of the second slot in normal CP;
For PSDCH and PSCCH, reference signals are created based on a fixed base sequence, cyclic shift and orthogonal cover code. For V2X sidelink communication, the cyclic shift for PSCCH is randomly selected in each transmission;
For in-coverage operation, the power spectral density of the sidelink transmissions can be influenced by the eNB; and
For measurement on the sidelink, the following basic UE measurement quantities are supported:
Sidelink reference signal received power (S-RSRP);
Sidelink discovery reference signal received power (SD-RSRP);
PSSCH reference signal received power (PSSCH-RSRP); and
Sidelink reference signal strength indicator (S-RSSI).

Currently, for 5G or New Radio (NR) standardisation, a sidelink has been specified in Release-16 for V2X communication, with the LTE sidelink being a starting point for the NR sidelink For NR sidelink, the following sidelink physical channels are defined:
Physical Sidelink Shared Channel (PSSCH);
Physical Sidelink Broadcast Channel (PSBCH);
Physical Sidelink Control Channel (PSCCH); and
Physical Sidelink Feedback Channel (PSFCH).

Furthermore, the following sidelink physical signals are defined:
Demodulation reference signals (DM-RS);
Channel-state information reference signal (CSI-RS);
Phase-tracking reference signals (PT-RS);
Sidelink primary synchronization signal (S-PSS); and
Sidelink secondary synchronization signal (S-SSS).

### Protocol Stacks

As will be appreciated by a person skilled in the art, communication via a wireless access interface (for example, uplink/downlink communications or D2D communication) may occur over one of three types of planes: a user plane carrying network user traffic, a control plane carrying network signalling traffic or a management plane carrying operations and administration traffic required for network management. Alternatively, the management plane may be considered as part of the control plane. For the following disclosure, reference to the control plane should be understood as referring to either just the control plane or the control plane and the management plane together.

As will also be appreciated by a person skilled in the art, a wireless interface is implemented by a protocol stack. Since the control plane and the user plane carry different types of network traffic, the protocol stack implementing the wireless access interface may be different for the control plane and user plane for the same wireless access interface.

### Mobility Between a gNB and a Relay UE

According to example embodiments a continuity of communications can be provided when a UE roams to a location where it is outside a radio coverage area of a gNB, but can continue communicating via the gNB using another UE which is inside the coverage area of the gNB and so can act as a relay node to that UE. In the following description, the UE which roams to a location which is outside the radio coverage of the gNB is referred to as a remote UE, whereas the other UE which is inside the coverage area of the gNB and so can act as a relay node will be referred to as a relay UE. Embodiments can provide an improvement in efficiency and reliability of communications with a remote UE by performing handover from a gNB to a relay UE, whilst as far as possible maintaining continuity of a communications session. In some embodiments, the gNB configures conditions to perform handover on the relay UE and/or remote UE. If these conditions are satisfied, the remote UE will perform handover. To this end, embodiments can provide an adaptation and configuration of a protocol stack for communicating packet data for both user plane and control plane which will now be explained.

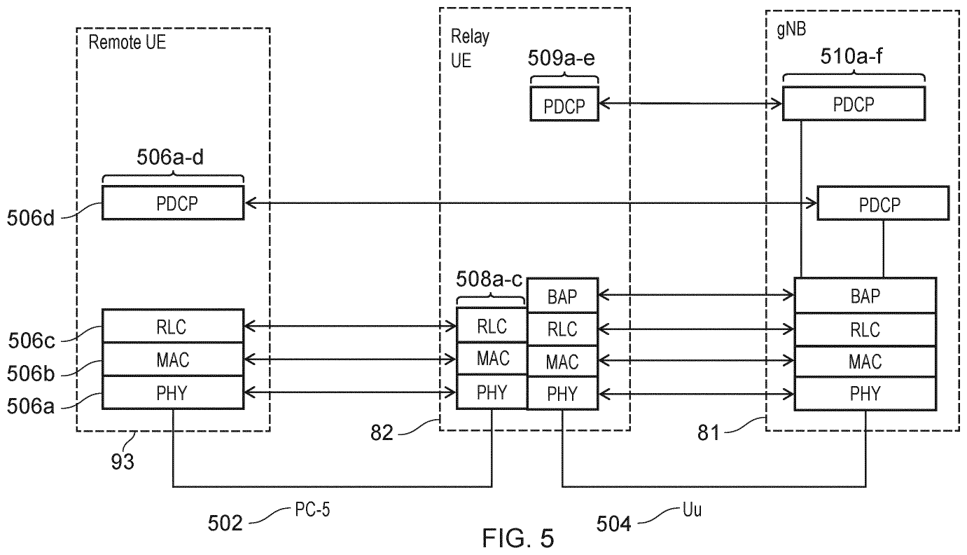

FIG. 5 shows a user plane protocol stack for user plane communication between a remote UE (such as UE 93), a relay UE (such as UE 82) and a gNB (such as radio infrastructure equipment 81) after a handover has taken place of the remote UE from the gNB to the relay UE. An example scenario to which FIG. 5 is applicable is as follows: the remote UE 93 performs radio communication with the gNB 81 over a Uu interface (not shown in the Figures). The gNB 81 then determines to handover the remote UE 93 to the relay UE 82. After the handover is complete, the remote UE 93 and the relay UE 82 perform radio communication over a PC-5 interface whilst the relay UE 82 and the gNB 81 perform radio communication over a Uu interface.

A protocol stack 506a-d within the remote UE 93 provides a physical (PHY) entity 506a, a medium access control (MAC) entity 506b, a radio link control (RLC) entity 506c and a Packet Data Convergence protocol (PDCP) entity 506d. The relay UE 82 contains two protocol stacks 508a-c, 509a-e. The protocol stack 508a-c in the relay UE 82 containing only PHY 508a, MAC 508b and RLC 508c entities operates in conjunction with corresponding peer entities 506a-c in the remote UE 93 to implement a PC-5 interface 502 between the remote UE 93 and the relay UE 82. Corresponding peer entitles are linked by a double headed arrow in FIG. 5. The PC-5 interface 502 allows wireless radio communication between the remote UE 93 and the relay UE 82. The protocol stack 509a-e in the relay UE containing PHY 509a, MAC 509b, RLC 509c, Backhaul Adaptation Protocol (BAP) 509d and PDCP 509e entities operates in conjunction with respective corresponding peer entities PHY 510a, MAC 510b, RLC 510c, BAP 510d and PDCP 510f in the gNB to implement a Uu interface 504 between the relay UE 82 and the gNB 81. The Uu interface 504 allows uplink and downlink communication between the relay UE 82 and the gNB 81.

From FIG. 5, the PDCP entity 506d within the protocol stack of the remote UE has a corresponding PDCP entity 510e within the protocol stack of the gNB. In this example, the PDCP entity 506d within the protocol stack of the remote UE has been maintained. In other words, the PDCP entity 506d was used in conjunction with the corresponding PDCP entity 510e in the gNB 81 to implement the Uu interface between the remote UE 93 and the gNB 81 before the handover procedure. According to the example embodiment the PDCP entity 506d is maintained in the remote UE 93 after the handover procedure in order to realise end-to-end security between the remote UE 93 and the gNB 81 so that, once the handover procedure is completed, the relay UE 82 cannot decrypt/encrypt data packets sent from the remote UE 93 to the relay UE 82 via the PC-5 interface which the relay UE 82 then forwards to the gNB via the Uu interface 504 and vice versa.

Therefore, in the following disclosure, each logical entity may be followed by an abbreviation of the wireless interface which the logical entity implements in cases where this will improve clarity. For example, the PHY 506a entity is used in implementing the PC-5 interface between the remote UE and the relay UE after the handover so may be referred to as “PHY(PC-5) 506a”. The PDCP entity 509e in the relay UE is used in implementing the Uu interface between the relay UE and the gNB after the handover and so may be referred to as “PDCP(Uu) 509e”. The PDCP entity 506d in the remote UE is used in implementing the Uu interface between the remote UE and the gNB before the handover and so may also be referred to as “PDCP(Uu) 506d”.

Other logical entities corresponding to higher layers may be present in the protocol stacks of the remote UE, the relay UE or the gNB but have not been shown here for clarity. For example, a service data adaptation protocol (SDAP) may be present in each of the remote UE, the relay UE and the gNB entity and may perform QoS flow to DRB mapping in the user plane.

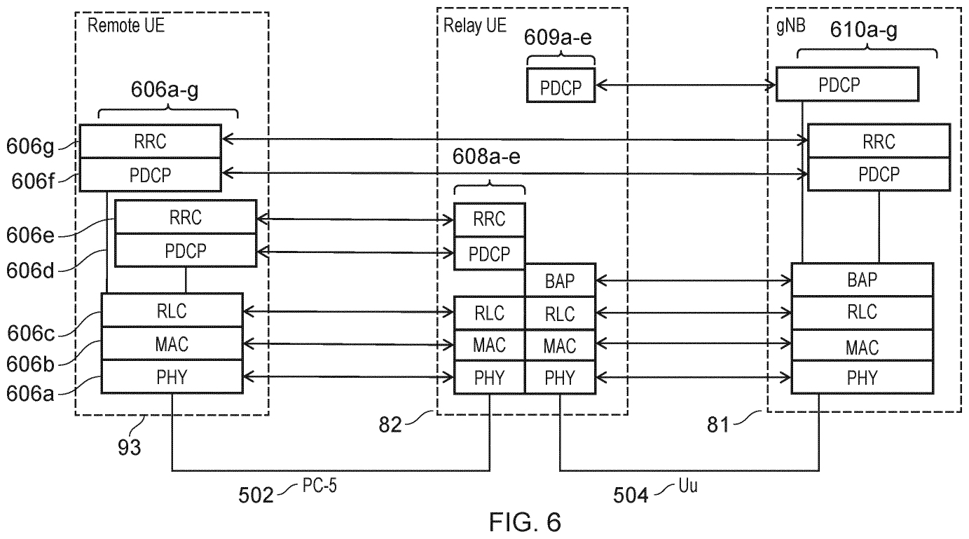

FIG. 6 shows a control plane protocol stack for control plane communication in the same scenario as in FIG. 5. A protocol stack 506a-d within the remote UE 93 provides a PHY entity 606a, a MAC entity 606b, an RLC entity 606c, a PDCP-PC-5 entity 606d, an RRC(PC-5) entity 660e, a PDCP(Uu) entity 606f and an RRC(Uu) entity 606g. The relay UE contains two protocol stacks 608a-e, 609a-e. The protocol stack 608a-e in the relay UE containing PHY 608a, MAC 608b, RLC 608c, PDCP(PC-5) 608d and RRC(PC-5) 608e entities operates in conjunction with corresponding peer entities 606a-e in the remote UE 93 to implement a PC-5 interface 502 between the remote UE 93 and the relay UE 82. The PC-5 interface 502 allows wireless radio communication between the remote UE 93 and the relay UE 82. The RRC(PC-5) 606e, 608e and PDCP(PC-5) 606d, 608d entities are configured in order to facilitate configuration of the PC-5 interface 502 between the remote UE and the relay UE. The protocol stack 609a-e in the relay UE containing PHY 609a, MAC 609b, RLC 609c, Backhaul adaptation Protocol (BAP) 609d and PDCP 609e entities operates in conjunction with respective corresponding peer entities PHY 610a, MAC 610b, RLC 610c, BAP 610d and PDCP(Uu) 610g in the gNB to implement a Uu interface 504 between the relay UE 82 and the gNB 81. It ill be appreciated that entities corresponding to higher layers, such as an RRC entity above PDCP 609e and an RRC entity above PDCP 610g, are presumed to be present but are not shown in the Figures for clarity). The Uu interface 504 allows uplink and downlink communication between the relay UE 82 and the gNB 81. From the Figure, the PDCP(Uu) entity 606f and the RRC entity(Uu) 606g within the protocol stack of the remote UE have a corresponding PDCP(Uu) 610e and a corresponding RRC(Uu) 610f entity within the protocol stack of the gNB. As in the example of FIG. 6, the maintenance of the PDCP(Uu) entity 606f ensures end-to-end security between the gNB and the remote UE so the relay node is unable to encrypt/decrypt data packets sent from the remote UE to the relay UE via the PC-5 interface which are forwarded to the gNB from the relay UE via the Uu interface and vice versa.

As shown in by the lines connecting the relevant entities in FIG. 6, protocol data units (PDUs) in the remote UE can be submitted from the PDCP (Uu) 606f entity to the RLC(PC-5) 606c entity and from the PDCP(PC-5) 606d to the RLC(PC-5) 606c entity.

Various embodiments to which the user plane and control plane protocol stacks of FIGS. 5 and 6 are applicable are now described.

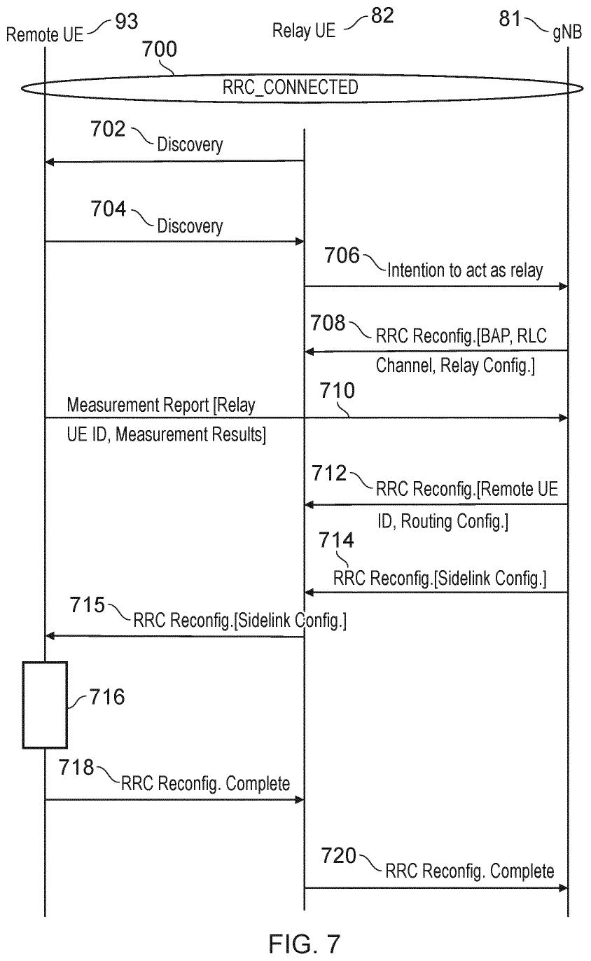

Referring to FIGS. 4 and 7, in some embodiments, a remote UE (such as UE 93) is initially in an RRC-Connected state 700 and is performing radio communication with a gNB (such as radio infrastructure equipment 81). The remote UE 93 may be initially within a coverage area 83 of the gNB state (not shown in FIG. 4) when the remote UE 93 is in the RRC_CONNECTED state. At a later time, the remote UE 93 may be outside the coverage area of the gNB as shown in FIG. 4. It may therefore be desirable for the remote UE to re-establish connection with the gNB 81 via a relay UE (such as UE 82). In other embodiments, it may be preferable to establish connection to a different gNB via a different relay UE. The relay UE 82 is within the coverage area 80 of the gNB 81. Based on measurements of a Uu interface between the remote UE 93 and the gNB 81 when the remote UE 93 is in the RRC_CONNECTED state, the remote UE may determine to initiate a discovery procedure 702, 704 in order to determine a suitable node to act as a relay between the remote UE 93 and the gNB 81. The remote UE 93 may determine to initiate the discovery procedure 702, 704 if, for example, measurements of the Uu interface between the remote UE 93 and the gNB 81 fall below a pre-defined threshold, such as a received signal strength threshold or the like. In other example embodiments, the relay UE 82 may perform the discovery of remote UE 93. In other example embodiments, the relay UE 82 may periodically broadcast discovery signals.

The discovery procedure 702, 704 begins with the relay UE 82 broadcasting a sidelink discovery signal 702 to the remote UE 93 over a PC-5 interface. The sidelink discovery signal provides an indication to the remote UE 93 that the relay UE 82 is capable of functioning as a relay between the remote UE 93 and the gNB 81. In some embodiments, the indication that the relay UE 82 is capable of functioning as a relay between the remote UE 93 and the gNB 81 is present in the broadcasted discovery signal from the relay 82 UE over a PC-5 interface. The relay UE 82 may be capable of acting as a relay because it is within the coverage area 83 of the gNB 81. In some embodiments, there may additionally be one or more other UEs (such as UE 91 and UE 92) close to the remote UE not capable of acting as a relay which can communicate with the remote UE via PC-5 interfaces 95, 94. The one or more other UEs 91, 92 close to the remote UE 93 may not be capable of acting as a relay because they are not within the coverage area 83 of the gNB 81. The remote UE 93 is capable of forming a PC-5 interface with either the relay node (such as interface 97) or any one of the UEs close to the remote UE (such as interfaces 95, 94). In the art, the remote UE 93, if it has determined that it will set-up a PC-5 interface, does not prioritise whether it will form the PC-5 interface with either the relay UE or one of the UEs which are not capable of acting as relays. However, in this embodiment, the sidelink discovery signal 702 providing the indication to the remote UE 93 that the relay UE 82 can act as a relay may be used by the remote UE 93 to prioritise the PC-5 interface 97 with the relay UE over the PC-5 interfaces 94, 95 which may be set up between the remote UE 93 and one of the UEs 91, 92 which are not capable of acting as relays. In this way, a method of prioritising connection of the remote UE 93 to the relay UE 81 can be established. In some embodiments, the indication to the remote UE 93 that the relay UE 82 can act as a relay may be used by the remote UE 93 to prioritise the PC-5 interface 97 with the relay UE may be included in a system information block (SIB).

In response to receiving the sidelink discovery signal 702, the remote UE 93 may transmit an indication 704 to the relay UE 82 that it intends to use the relay UE 82 as a relay between the remote UE 93 and the gNB 81. The remote UE 93 may transmit the indication that it intends to use the relay UE as a relay as a result of on, for example, measurements of the Uu interface between the remote UE 93 and the gNB 81 when the remote UE 93 is in the RRC_CONNECTED state 700. The measurements may indicate that a channel quality for the Uu interface is below a pre-determined threshold.

In response to receiving, from the remote UE 93, the indication 704 that the remote UE 93 intends to use the relay UE 82 as a relay, the relay UE 82 transmits an indication 706 to the gNB 81 informing the gNB 81 that the relay UE 82 intends to be used as a relay between the remote UE 93 and the gNB 81. In response to receiving the indication 706 that the relay UE 82 is to be used as a relay, the gNB 81 may configure the relay UE 82 with one or more relay characteristics. Examples of the one or more relay characteristics include, but are not limited to, a BAP entity configuration, a routing table and/or an identity of a physical channel between the remote UE 93 and the relay UE 82 which the remote UE 93 should measure quality characteristics of. It will be appreciated that the BAP entity could be any entity forming part of an adaptation layer as will be a appreciated by a person skilled in the art. The gNB 81 then transmits the relay characteristics 708 to the relay UE 82. The remote UE 93 sends 710 a measurement report of the relay UE 82. The measurement report may include, but is not limited to, an identity of the relay UE, a quality of a physical channel between the remote UE and the relay UE and/or cell measurements based on reference signals such as a synchronisation signal block (SSB) or a Channel State Information Reference Signal (CSI-RS) of a cell. In some embodiments, more than one relay UE may have sent indications to the remote UE that they are capable of acting as a relay between the remote UE and the gNB. In this embodiment, the remote UE may send a measurement report for each of the relay UEs. The measurement reports sent for each of the relay UEs may be based on the RRC configuration received 708 from the gNB.

The gNB 81 receives 710 the measurement report from the remote UE 93 and, on the basis of the measurement report, determines whether or not to perform to handover the remote UE 93 to the relay UE 82. If the gNB 81 determines that the hand over should occur, then the gNB 81 transmits 712, to the relay UE, an RRC reconfiguration in order to prepare resources for the remote UE 93. The RRC reconfiguration may be include, but is not limited to, an identification of the remote UE 91, an indication of resources which were required for communication between the remote UE and the gNB when the remote UE was in the RRC_CONNECTED state, an indication of quality of service (QoS) flows required for bearers, whether a new RLC channel is to be established and, if so, an identity of the RLC channel to be established and/or routing configuration in the BAP entity of the relay UE (such as BAP entity 609d). The gNB 81 also transmits 714 an RRC reconfiguration to the relay UE 82 to be forwarded 715 onto the remote UE 93. The RRC configuration transmitted from the gNB 81 to the remote UE 93 may include sidelink parameters. Sidelink parameters may be related to either a sidelink between a remote UE and one or more other UEs not capable of acting as relays (such as UE as 91 and 92) or a sidelink 97 between a remote UE and a relay UE. The configuration of a sidelink 94, 95 between a remote UE and one or more other UEs not capable of acting as relays may be transmitted (not shown in FIG. 7) from the gNB 81 to the remote UE 93 before the initiation of the discovery procedure in step 702 when the remote UE is in the RRC_CONNECETD state 700. In the present embodiment, the sidelink parameters transmitted 714 from the gNB 81 to the remote UE 93 are related to a configuration of a relay sidelink 97 between the remote UE 93 and the relay UE 82. The sidelink 97 between the remote UE 93 and the relay UE 82 facilitates transport of Uu RRC messages.

After receiving 714, 715 the RRC configuration from the gNB 81, the remote UE 93 may continue to use a security context established between the remote UE 93 and the gNB 81 when the remote UE 93 was in the RRC_CONNECTED state 700. The remote UE may suspend or release one or more of a RLC, MAC and/or PHY entity used for the Uu interface between the remote UE 93 and the gNB 81 when the remote UE 93 was in RRC_CONNECTED state 700. However, the remote UE 93 may continue to use a Uu PDCP entity used for the Uu interface between the remote UE 93 and the gNB 81 when the remote UE 93 was in RRC_CONNECTED state 700, such as the Uu PDCP entity 606f in the control plane in FIG. 6 and the Uu PDCP entity 506d in the user plane in FIG. 5. The remote UE 93 may therefore maintain end to end security with the gNB 81.

The remote UE may configure 716 sidelink protocol stacks (such as protocol stacks 506a-c and 508a-c in the user plane in FIG. 5 and protocol stacks 606a-e and 608a-e in the control plane in FIG. 6). In addition to the configuring of the sidelink protocol stacks, the remote UE may suspend or release one or more of a RLC, MAC and/or PHY entity used for the Uu interface between the remote UE 93 and the gNB 81 when the remote UE 93 was in RRC_CONNECTED state 700. The decision to suspend or release protocol entities may be performed by the UE based on a network configuration. For example, the gNB may determine to suspend or release protocol entities and transmit this decision to the remote UE based on a capability of the remote UE to support relay communication and/or a presence of relay UEs in the coverage area of the gNB 83. If the gNB does not determine to suspend or release protocol entities or does not transmit this decision to the remote UE then the remote UE only resets a MAC entity used to implement the Uu interface between the remote UE 93 and the gNB 81 when the remote UE 93 was in RRC_CONNECTED state 700.The configuration of the sidelink protocol stacks may be included in the RRC configuration message transmitted 714, 715 from the gNB to the remote UE.

After the remote UE 93 has completed the RRC reconfiguration 716, the remote UE 93 may send an indication 718 to the relay UE 82 that the RRC configuration has been completed. The relay UE 82 will transmit 720 the indication that the remote UE 93 has completed the RRC reconfiguration to the gNB 81. The RRC complete messages 718, 720 may be transported in a sidelink RRC (SL-RRC) container (discussed below) so that the gNB can determine that the indication that the RRC configuration has been completed is from the remote UE 93 rather than the relay UE 82.

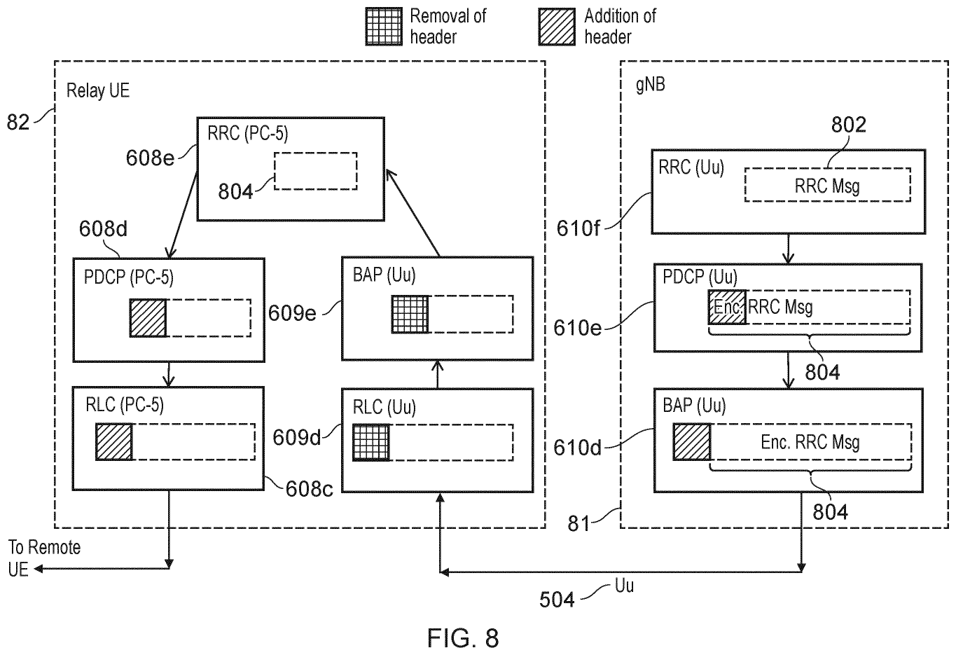

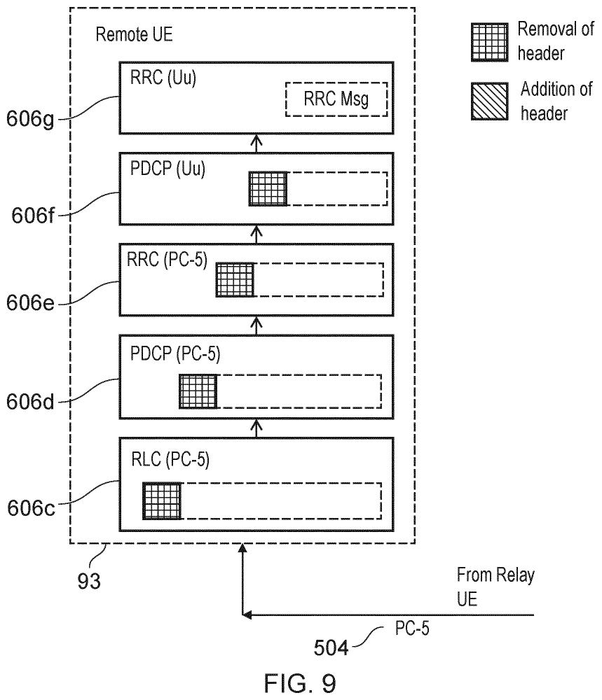

A more detailed understanding of the transmission of the RRC reconfiguration message 714, 715 in a SL-RRC container may be obtained with reference to FIGS. 8 and 9. FIGS. 8 and 9 use the same protocol stacks as FIGS. 5 and 6 and the same reference numeral numbering will be adhered to for clarity. Not all of the entitles present in FIGS. 5 and 6 are present in FIGS. 8 and 9 to improve the clarity of the Figures but they are nevertheless assumed to be present. In the gNB 81, the RRC(Uu) entity 610f generates an RRC reconfiguration message (RRC Msg 802) which it intends to transmit 714, 715 to the remote UE 93. After the RRC reconfiguration message 802 has been generated, the RRC(Uu) entity 610f submits the RRC Msg to the PDCP(Uu) entity 610e. The PDCP(Uu) entity 610e performs encryption on the RRC Msg and adds a PDCP header to provide an encrypted RRC Msg 804 (a diagonal lines in FIGS. 8 and 9 indicate the addition of a header whereas horizontal lines indicate the removal of a header). The Encrypted RRC message 804 is shown only at selected stages of FIG. 8 but it will be appreciated that the encrypted RRC message 804 will be present in intermediate stages until the message is unencrypted as will be discussed below. After the RRC msg 802 has been encrypted, the encrypted RRC Msg 804 is submitted to the to the BAP entity 610d for routing. The BAP entity 610d adds a BAP header to a payload including the encrypted RRC msg 804. Although not shown in FIG. 8, the encrypted RRC msg 804 passes through the RLC 610c, MAC 610b and PHY 610a entities of the gNB, and each of those entities adds a corresponding header and performs functions in accordance with those entities as will be appreciated by a person skilled in the art. When the encrypted RRC msg 804 is summited to the PHY entity 610a, the gNB 81 transmits (not shown), via the UU interface 504, the encrypted RRC msg 804 to the PHY(Uu) entity 609a of the relay UE 82. The encrypted RRC msg 804 is forwarded through the MAC(Uu) 609b and RLC(Uu) 609c entities of the relay UE 82 to the BAP(Uu) 609d. During the forwarding, each entity removes the header added by each corresponding peer entity in the gNB 81. The BAP (Uu) 609d entity submits the encrypted RRC msg 804 to the RRC(PC-5) entity 608e of the relay UE 82. In this way the RRC Msg remains encrypted and is unreadable by the relay UE 82. In some embodiments, the encrypted RRC msg 804 may be forwarded onto the PDCP(PC-5) 609e entity of the relay UE. In this embodiment, the PDCP(PC-5) 609d entity encrypts the encrypted RRC msg 804 to form a doubly encrypted RRC msg to provide double security. In other embodiments (not shown in FIG. 8), when double security is not required, the RRC(PC-5) entity 608e submits a payload containing the encrypted RRC message directly to the RLC(PC-5) 608c entity. The RLC(PC-5) entity 608c then submits the encrypted RRC msg through the remaining entities of the relay UE 608a-b and the encrypted RRC msg is transmitted to the remote UE 93 via the PC-5 interface between the PHY(PC-5) 608a entity of the relay UE 82 and the PHY(PC-5) entity 606a of the remote UE 93. The skilled person will appreciate that the encrypted RRC Msg is forwarded through the lower layers of the remote UE 93 to reach the RLC(PC-5) entity 606c. The RLC(PC-5) entity 606c forwards the encrypted RRC msg to the PDCP(PC-5) entity 606d, the PDCP(PC-5) forwards the encrypted RRC msg to the RRC(PC-5) 606e entity, the RRC(PC-5) 606e entity forwards the encrypted RRC Msg to the PDCP(Uu) entity 606f.The PDCP(Uu) entity 606f performs decryption based on stored keys for the coverage area 83 of the gNB 81. The PDCP(Uu) entity 606f then forwards the RRC msg to the RRC(Uu) entity 606g. The remote UE 93 then applies the configuration specified in the RRC Msg.

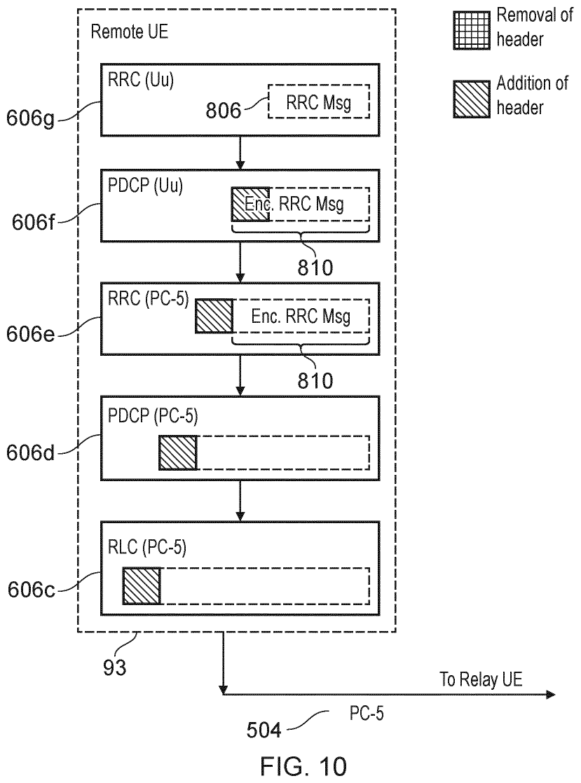

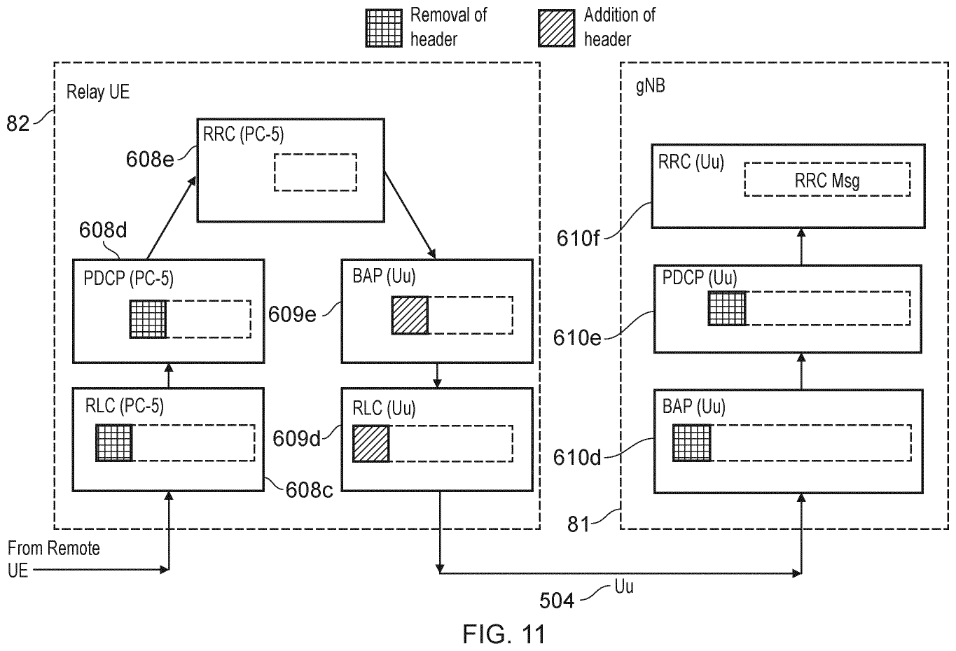

A more detailed understanding of the transmission of the RRC complete messages 718, 720 in SL_RRC containers may be obtained with reference to FIGS. 10 and 11. FIGS. 10 and 11 are the same as FIGS. 8 and 9 except that the direction of transmission/submission has been reversed. The RRC complete msg 806 is encrypted by the PDCP(Uu) entity 606f in the remote UE 93 to provide an encrypted RRC complete message 810 which is decrypted by the PDCP(Uu) entity 610e in the gNB. The intermediate transmissions/functions of the entities of the protocol stacks are reversed as compared with FIGS. 8 and 9 as will be a appreciated by a person skilled in the art.

In some embodiments, the BAP(Uu) 609d entity in the relay UE 82 may distinguish between signalling radio bearers (SRBs) and data radio bearers (DRBs) in the remote UEs traffic so that an appropriate RLC channel is chosen for transport from the relay UE 82 to the gNB 81. The RRC configuration complete message may terminate in an RRC entity of a central unit(CU) (not shown).

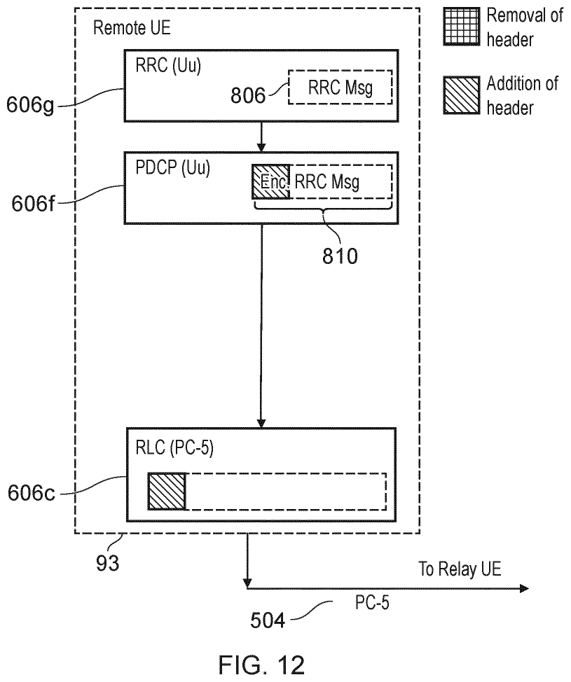

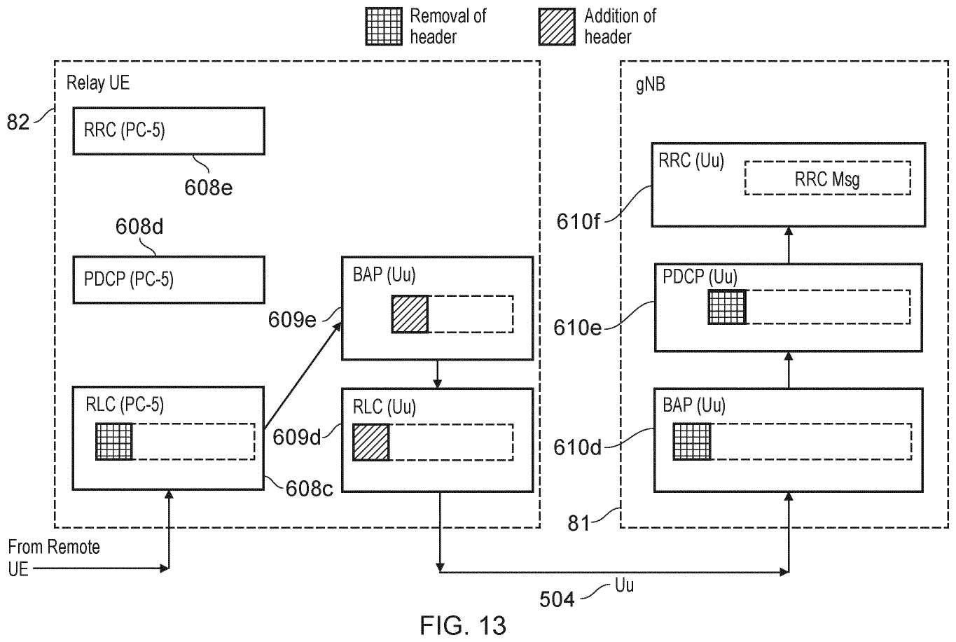

In an alternative embodiment, the transmission of the RRC complete messages 718, 720 may be obtained with reference to FIGS. 12 and 13. In this embodiment, the RRC complete message 806 is encrypted by the PDCP(Uu) 606f entity to provide an encrypted RRC complete message 810. After submission of the encrypted RRC complete message 810 to the RLC(PC-5) entity 606c, the RLC(PC-5) 606c entity creates a new field in an RLC header that indicates that the encrypted RRC complete message 810 was submitted by the PDCP(Uu) 606f entity (rather than the PDCP(PC-5) entity 606d. The indication that the PDCP(Uu) entity 606f submitted the encrypted RRC message 810 to the RLC(PC-5) entity 609c is an example of a sidelink parameter referred to previously. The encrypted RRC message is then forwarded to the RLC(PC-5) entity 609c of the relay UE 82. The relay UE then determines on the basis of the new field in the RLC header, to submit the encrypted RRC message to the BAP(Uu) 609e entity rather than the PDCP(PC-5) entity of the relay UE 82. The encrypted RRC message 810 is then forwarded in the same way as in FIGS. 10 and 11.

The indication that the PDCP(Uu) entity 606f submitted the encrypted RRC message 810 to the RLC(PC-5) entity 609c may alternatively be indicated in a PDCP header or by creating a new PDCP(Uu) entity when the PDCP(Uu) entity 606f communicates. Alternatively, a new RLC(PC-5) entity (not shown) may be created when the PDCP(Uu) 606f entity communicates. By contrast, a new PDCP or RLC entity is created for each radio bearer in current specifications. The new RLC entity will communicate only with the PDCP(Uu) 606f entity.

In an alternative embodiment (not shown), the transmission of the RRC complete messages 718, 720 may be obtained by introducing a BAP into the remote UE 93. In this embodiment, the BAP entity in the remote UE will have a corresponding peer BAP(PC-5) entity in the relay UE (which is different from BAP(Uu) entity 609d). The corresponding peer entity submits the encrypted RRC message to the BAP(Uu) entity 609d.

The above embodiments provide a method to enable routing of different types of traffic (SRB, DRB, PC-5, Uu) between remote a UE, a relay UE and a gNB for both uplink and downlink communication.

In an alternative embodiment (not shown in the Figures), the RRC configuration complete messages prepared in response to 712, 714, 715 and sent in 718, 720 are combined. In this embodiment, the PDCP(Uu) 606f entity of the remote UE 93 does not encrypt the RRC configuration complete message. The combined message is transmitted by the RRC(PC-5) entity 606e of the remote UE 93 to the RRC(PC-5) entity 609e of the relay UE 82 via the PC-5 interface through the lower layers. The combined message is then transmitted by the relay UE to the RRC(Uu) entity 610f of the gNB via the Uu interface through the lower layers.

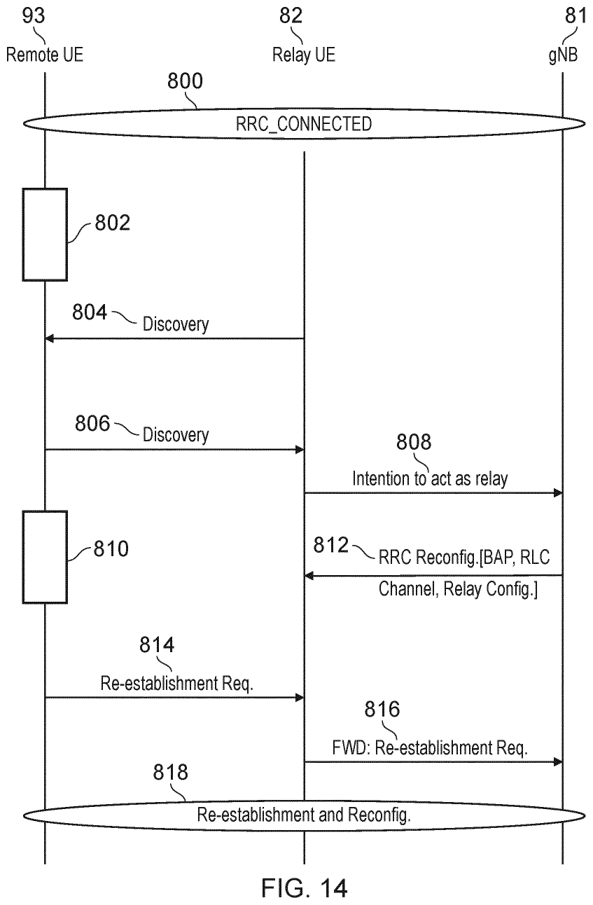

In another embodiment, referring to FIG. 14, a remote UE 93 is initially in an RRC_CONNECTED state 800 and performing radio communication with a gNB 81 via the Uu interface. Whilst in the RRC_CONNECTED state 800, the remote UE 93 may be inside the coverage area 83 of the gNB 81 (not shown). The remote UE 93 may then trigger radio link failure (RLF) 802. The remote UE 93 may declare RLF if it has lost synchronization with the gNB 81 (possibly due to degradation of an air interface between the remote UE 93 and the gNB 81 or the remote UE 93 moving outside the coverage area 83 of the gNB 81). In response to the remote UE 93 triggering the RLF 802, the remote UE 93 may continue to use a security context established between the remote UE 93 and the gNB 81 when the remote UE 93 was in the RRC_CONNECTED state 700. The remote UE may suspend or release one or more of a RLC, MAC and/or PHY entity used for the Uu interface between the remote UE 93 and the gNB 81 when the remote UE 93 was in RRC_CONNECTED state 700. The decision to suspend or release protocol entities may be performed by the UE based on a network configuration. For example, the gNB may determine to suspend or release protocol entities and transmit this decision to the remote UE based on a capability of the remote UE to support relay communication and/or a presence of relay UEs in the coverage area of the gNB 83. If the gNB does not determine to suspend or release protocol entities or does not transmit this decision to the remote UE then the remote UE only resets a MAC entity used to implement the Uu interface between the remote UE 93 and the gNB 81 when the remote UE 93 was in RRC_CONNECTED state 700. However, the remote UE 93 may continue to use a Uu PDCP entity used for the Uu interface between the remote UE 93 and the gNB 81 when the remote UE 93 was in RRC_CONNECTED state 700, such as the Uu PDCP entity 606f in the control plane in FIG. 6 and the Uu PDCP entity 506d in the user plane in FIG. 5. The remote UE 93 may therefore maintain end to end security with the gNB 81 if it reconnects to the gNB 81 via the relay UE 82. After declaring RLF 802, the remote UE initiates a cell selection procedure in an attempt to re-establish connection with a gNB. The remote UE may also search for nearby candidate relay UEs which have a capability to act as a relay node between the remote UE and a gNB. It will be appreciated that the remote UE could establish connection with a gNB other than gNB 81 via a relay UE. For clarity of explanation, in this example, the remote UE 93 will connect to the gNB 81 via the relay UE 93 as in FIG. 7.

The remote UE 93 may search for candidate relay UEs in a case where the remote UE 93 cannot determine a suitable cell. The candidate relay UEs may broadcast a sidelink discovery signal to the remote UE in the same way as FIG. 7. The remote UE 93 then determines the relay UE 82. The relay UE 82 then transmits 808 an indication to the gNB 81 that the relay UE 82 intends to act as a relay between the remote UE 93 and the gNB 81. Steps 804, 806, 808 and 812 in FIG. 14 correspond to steps 702, 704, 706 and 708 in FIG. 7 respectively. The remote UE 93 then establishes a PC-5 connection with the relay UE 82 (such as in the example in FIG. 6). The remote UE 93 then transmits a Uu RRC re-establishment request message to the relay UE 82. The relay UE 82 then forwards the reestablishment request to the gNB 81. After the gNB has received the re-establishment request, the remote UE 93 re-establishes connection with the gNB 81 via the relay UE 82. The re-establishment request messages may be transmitted in the same ways as the RRC configuration complete messages as discussed above.

In other embodiments, conditional re-establishment may be configured in the remote UE. In particular, an RRC reconfiguration message which contains the conditions to perform a re-establishment procedure (such as the message transmitted in step 812) may be transmitted while the remote UE 93 is still in the RRC_CONNECTED state 800. The remote UE 93 may the apply this RRC configuration after declaring RLF and subsequent re-establishment.

In another embodiment, a remote UE (such as UE 93) is initially in an RRC_INACTIVE state and within a coverage area (such as coverage area 83) of a gNB (such as radio infrastructure equipment 81). If the remote UE 93 determines that it should enter a cell selection procedure (for example, because the remote UE 93 moves outside the coverage area 83 of the gNB 81) then the remote UE 93 may search for a radio connection with a gNB. During the cell selection procedure, the remote UE 93 may also search for potential connections to one or more relay UEs via PC-5 interfaces. In this embodiment, the remote UE 93 may determine to connect to one of the relay UEs via a PC-5 interface (such as UE 82). A relay UE may or may be part of a RAN (Radio Access Network) Notification Area (RNA). If the relay UE is part of the RNA, then the remote UE 93 remains in the RRC_INACTIVE state and within the coverage are 83 of the gNB 81. If the relay UE is not part of the RNA, then the relay UE transmits an SIB to the remote UE and the SIB broadcasts RNA.

If the remote UE 93 determines that it should establish radio connection with the gNB 81 with a coverage area 83 enclosing the remote UE, then the remote UE transmits an RRC resume message to the relay UE. The relay UE then transmits the RRC resume message to the gNB. The Resume message may be embedded in an SL-RRC container or similar (discussed above) so that the gNB can determine that the Resume message is from the remote UE rather than the relay UE. In response to the gNB receiving the RRC resume message, the remote UE enters the RRC_CONNECTED state and establishes radio connection with the gNB.

In another embodiment, if a remote UE is initially in an RRC_IDLE state and within a coverage area of a gNB, the remote UE may enter a cell selection procedure (for example, because the remote UE 93 moves outside the coverage area 83 of the gNB 81). During the cell selection procedure, the remote UE may search for a radio connection with a gNB. During the cell selection procedure, the remote UE may also search for potential connections to one or more relay UEs via PC-5 interfaces. If the remote UE determines no suitable cell in the cell selection procedure, then the remote UE may set up a PC-5 interface with a suitable relay UE via a discovery procedure as mentioned above. In this embodiment, the remote UE is still in the RRC_IDLE state.

In another embodiment, if a remote UE is initially performing radio communication via a PC-5 interface with a relay UE, then the remote UE performs measurements associated with the radio connection between the remote UE and the relay UE. For example, the measurement results may contain an indication of the quality of the radio link between the remote UE and the relay UE. The measurement results are transmitted to the relay UE by the remote UE and the relay UE transmits the measurement results to a gNB. The measurement results are transmitted in a SL-RRC container or similar approach (discussed above) so that the gNB determines that the measurement results are from the remote UE rather than the relay UE. On the basis of the measurement results, the gNB determines that a handover is appropriate. The gNB transmits an RRC reconfiguration message (such as the RRC reconfiguration message transmitted in step 812 to the remote UE via the relay UE. On receiving the RRC reconfiguration message, the remote UE sends an RRC Reconfiguration complete message directly to the gNB. The remote UE may perform a random access channel (RACH) procedure to establish a radio connection with the gNB via a Uu interface.

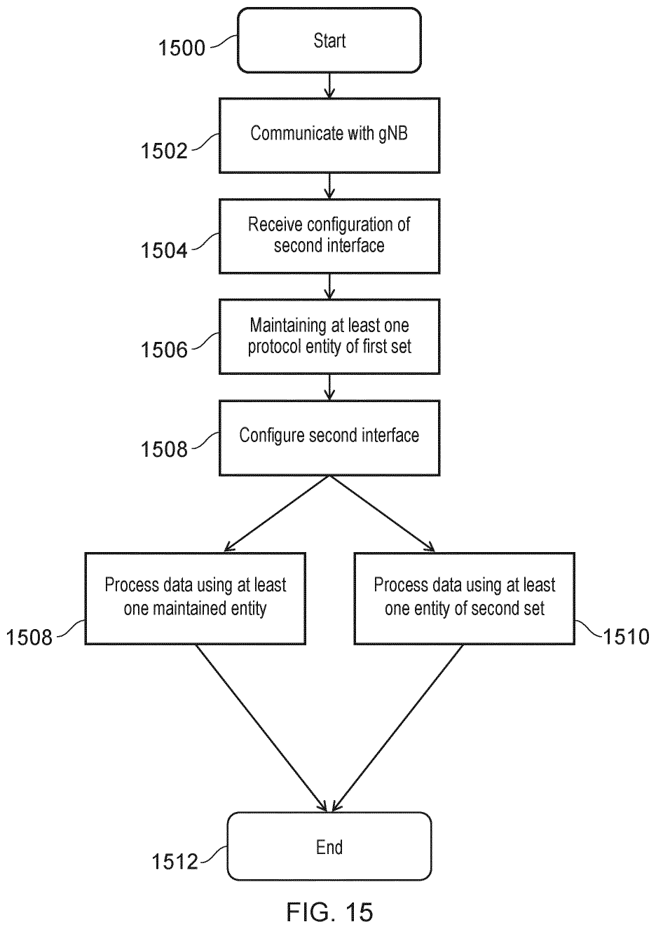

FIG. 15 shows a flow diagram illustrating a process of communications in a communications system in accordance with embodiments of the present technique. The communications system is a wireless communications network including a first communications device, a second communications device and an infrastructure equipment. The first communications device may be a remote UE, such as UE 93. The second communications device may be a relay UE, such as UE 82. The infrastructure equipment may be a gNB, such as gNB 81. As state above, the the use of a specific term in relation to certain example implementations is not intended to indicate these implementations are limited to a certain generation of network that may be most associated with that particular terminology. For example, the infrastructure equipment may alternatively be a TRP 10 with an associated distributed unit (DU) 42 and control unit (CU) 40. After a start point point 1500, processing moves to step 1502 wherein the first communications device communicates 1502 with the infrastructure equipment using a first wireless access interface implemented by a first set of protocol entities in the first communications device and a corresponding first set of peer protocol entities in the infrastructure equipment. This communication may correspond to communication over a Uu interface when the first communications device is in an RRC_CONNECTED state. The first set of protocol entities in the first communications device may correspond to a set of protocol entities used to implement the Uu interface between the first communications device and the infrastructure equipment. The first wireless access interface may be the Uu interface between the first communications device and the infrastructure equipment. In step 1504, the first communications device receives, from the infrastructure equipment, an indication of a configuration of a second wireless access interface for communication between the first communications device and the second communications device, the second wireless access interface being implemented by a second set of protocol entities in the first communications device and a corresponding second set of peer protocol entities in the second communications device. In other words, the infrastructure equipment configures a second wireless access interface (such as a PC-5 interface) between the first communications device and the second communications device and transmits this configuration to the first communications device. The second set of protocol entities in the first communications device may correspond to protocol entitles used to implement a PC-5 interface between the first communications device and the second communications device. In step 1506, the first communications device maintains at least one of the first set of protocol entities in the first communications device. In some embodiments, the first communications device declares a radio link failure or the first communications device hands over from the infrastructure equipment to the second communications device. The first communications device may then suspend or release one or more protocol entities used to implement the Uu interface between the first communications device and the infrastructure equipment. However, the first communications device will maintain/refrain from suspending or releasing at least one of these entities. In step 1508, the first communications device configures, on a basis of the indication of the configuration of the second wireless access interface received from the infrastructure equipment, the second wireless access interface for communication between the first communications device and the second communications device. In other words, the first communications devices uses the configuration sent by the infrastructure equipment to set up a PC-5 interface between the first communications device and the second communications device. Processing then proceeds either to step 1508 or 1510 depending on where the first communications device desires to transmit data. If the first communications device desires to transmit data to the infrastructure equipment then processing proceeds to step 1508 and the first communications device processes data using at least one of the maintained protocol entities of the first set of protocol entities in the first communications device. In other words, the first communications device may use a maintained PDCP entity from the Uu interface between the first communications device and the infrastructure equipment to encrypt data intended for the infrastructure equipment to render it unreadable by the second communications device. If the first communications device desires to transmit data to the infrastructure equipment then processing proceeds to step 1510 and the first communications device may use one of the second set of protocol entities in the first communications device. In other words, the first communications device may use one of the protocol entities, such as a PDCP entity, of the PC-5 interface between the first communications device and the second communications device to encrypt the data if the data is intended for the second communications device. The processing procedure may then end 1512.

The above embodiments facilitate routing of data between the first communications device, the second communications device and the infrastructure equipment.

According to the embodiments described above, a communications device acting as a relay communications device may operate as a relay to a remote communications device by receiving (714), from an infrastructure equipment of a wireless communications network, an indication of a configuration of a second wireless access interface for communication between the remote (first) communications device and the relay communications device, the indication of the second wireless access interface being related to a first wireless access interface for communication between the remote communications device and the infrastructure equipment. The method includes forming the second wireless access interface by a second set of protocol entities in the relay communications device corresponding to second set of peer protocol entities in the remote communications device (608a-e, 508a-c), the second set of protocol entities corresponding to a first set of protocol entities in the remote communications device, which correspond with a first set of peer protocol entitles in the infrastructure equipment implementing the first wireless access interface. The method comprises transmitting (715), to the remote communications device, the indication of the configuration of the second wireless interface, and receiving processed data from one of the remote communications device or the infrastructure equipment for communicating to the other of the remote communications device or the infrastructure equipment.

In one example the processed data includes encrypted data according to the end to end communication between the remote communications device and the infrastructure equipment.

According to example embodiments the operation of the relay communications includes determining that the processed data was received from the remote (first) communications device, determining whether the processed data received from the first communications device was processed using either at least one maintained protocol entity of the first set of protocol entities in the first communications device, or at least one of the second set of protocol entities in the first communications device if the data is intended for the second communications device, and transmitting the processed data on to the infrastructure equipment if it is determined that the processed data was processed using at least one of the maintained protocol entities of the first set of protocol entities in the first communications device, or extracting data from the processed data if it is determined that the processed data was processed using at least one of the second set of protocol entitles in the first communications device. The extracting the processed data can include decrypting the processed data or using the processed data by for example applying another process.

Those skilled in the art would also appreciate that such infrastructure equipment and/or wireless communications networks as herein defined may be further defined in accordance with the various arrangements and embodiments discussed in the preceding paragraphs. It would be further appreciated by those skilled in the art that such infrastructure equipment and wireless communications networks as herein defined and described may form part of communications systems other than those defined by the present invention.

The following numbered paragraphs provide further example aspects and features of the present technique:

Paragraph 1. A method of operating a first communications device forming part of a wireless communications network comprising a second communications device and an infrastructure equipment, the method comprising
communicating via the infrastructure equipment using a first wireless access interface implemented by a first set of protocol entities in the first communications device and a corresponding first set of peer protocol entities in the infrastructure equipment
receiving, from the infrastructure equipment, an indication of a configuration of a second wireless access interface for communication between the first communications device and the second communications device, the second wireless access interface being implemented by a second set of protocol entities in the first communications device and a corresponding second set of peer protocol entities in the second communications device;
maintaining at least one of the first set of protocol entities in the first communications device;
   configuring, on a basis of the indication of the configuration of the second wireless access interface received from the infrastructure equipment, the second wireless access interface for communication between the first communications device and the second communications device;
processing data using either
at least one of the maintained protocol entities of the first set of protocol entities in the first communications device if the data is intended for the infrastructure equipment, or
at least one of the second set of protocol entities in the first communications device if the data is intended for the second communications device to facilitate routing of the data between the first communications device, the second communications device and the infrastructure equipment.

Paragraph 2. A method according to paragraph 1, comprising
transmitting the processed data intended for the infrastructure equipment to the second communications device for forwarding on to the infrastructure equipment.

Paragraph 3. A method according to paragraph 1, wherein the processing the data comprises encrypting the data.

Paragraph 4. A method according to paragraph 1, wherein maintaining the at least one protocol entity of the first set of protocol entities in the first communications device comprises
maintaining a first Packet Data Convergence Protocol Entity (PDCP) of the first set of protocol entities in the first communications device to maintain end-to-end security between the first communications device and the infrastructure equipment.

Paragraph 5. A method according to any of paragraphs 1 to 4, wherein one or more of a MAC entity, RLC entity and PHY entity of the first set of protocol entities in the first communications device is suspended or released.

Paragraph 6. A method according to paragraph 4 or 5, wherein the maintained PDCP entity of the first set of protocol entitles in the first communications device submits the processed data to a Radio Link Control (RLC) entity of the second set of protocol entities in the first communications device if the data is intended for the infrastructure equipment.

Paragraph 7. A method according to paragraph 4 or 5, wherein a PDCP entity of the second set of protocol entitles in the first communications device submits the processed data to a Radio Link Control (RLC) entity of the second set of protocol entities in the first communications device if the data is intended for the second communications device.

Paragraph 8. A method according to any of paragraphs 1 to 7, wherein the RLC entity of the second set of protocol entities in the first communications device assigns a marker to the processed data to identify whether the data was generated in an RRC entity of the maintained protocol entities of the first set of protocol entities in the first communications device or whether the data was generated in an RRC entity of the second set of protocol entities in the first communications device to facilitate routing of the data between the first communications device, the second communications device and the infrastructure equipment.

Paragraph 9. A method according to paragraph 8, wherein the second set of protocol entities in the first communications device includes a Backhaul Adaptation Protocol (BAP) entity which is used to identify whether the data was generated in an RRC entity of the maintained protocol entities of the first set of protocol entities in the first communications device or whether the data was generated in an RRC entity of the second set of protocol entities in the first communications device.

Paragraph 10. A method according to any of paragraph 1 to 9, comprising
receiving, from the second communications device, an indication that the second communications device can act as a relay between the first communications device and the infrastructure equipment

Paragraph 11. A method according to paragraph 10, wherein the indication that the second communications device can act as a relay between the first communications device and the infrastructure equipment is included in a discovery signal.

Paragraph 12. A method according to any of paragraphs 1 to 10, wherein the indication that the second communications device can act as a relay between the first communications device and the infrastructure equipment is included in a system information block (SIB).

Paragraph 13. A method according to any of paragraphs 1 to 12, wherein the wireless communications network comprises one or more other communications devices which do cannot act as a relay between the first communications device and the infrastructure equipment, and the first communications device uses the indication that the second communications device can act as a relay between the first communications device and the infrastructure equipment to prioritise the configuring of the second wireless access interface for communication between the first communications device and the second communications device over a configuring of a wireless access interface for communication with the one or more other communications devices.

Paragraph 14. A method according to any of paragraphs 1 to 13, comprising determining that the first communications device should handover to the second communications device.

Paragraph 15. A method according to paragraph 14, wherein the determining that the first communications device should handover to the second communications device is based on a signal received from the infrastructure equipment.

Paragraph 16. A method according to paragraph 14, wherein the determining that the first communications device should handover to the second communications device is based pre-defined conditions.

Paragraph 17. A method according to any of paragraphs 1 to 16, comprising
transmitting, to the infrastructure equipment, a measurement report including at least an identification of the second communications device.

Paragraph 18. A method according to paragraph 17, wherein the measurement report includes measurements of reference signal received power (RSRP) of the second communications device.

Paragraph 19. A method according to any of paragraphs 1 to 18, wherein the data intended for the infrastructure equipment includes, an indication that the configuration of the second wireless access interface for communication between the first communications device and the second communications device is completed.

Paragraph 20. A method according to any of paragraphs 1 to 13, wherein the first communications device is communicating with the infrastructure equipment in a connected state via the first wireless access interface and the first communications device declares a radio link failure.

Paragraph 21. A method according to paragraph 20, wherein the signal intended for the infrastructure equipment includes, a request to re-establish a connection to the infrastructure equipment.

Paragraph 22. A method according to any of paragraphs 1 to 13, wherein the first communications device is communicating with the infrastructure equipment within a coverage area of the infrastructure equipment in an inactive state via the first wireless access interface and the first communications device determines that it should enter a cell selection procedure and searches for potential sidelink connections with candidate relay communications devices.

Paragraph 23. A method according to any of paragraphs 1 to 13, wherein the first communications device is communicating with the infrastructure equipment within a coverage area of the infrastructure equipment in an idle state via the first wireless access interface and the first communications device determines that it should enter a cell selection procedure and searches for potential sidelink connections with candidate relay communications devices.

Paragraph 24. A method of communicating by a communications device, the method comprising
establishing a packet data connection from the communications device via an infrastructure equipment of a wireless communications network to support a communications session, the connection being formed using a first packet data protocol entity in the communications device via a first wireless communications interface between the communications device and the infrastructure equipment to a peer first packet data protocol entity in the infrastructure equipment,
maintaining the communications session by
establishing a second packet data connection between the communications device and the other communications device acting as a relay node via a second wireless access interface between the communications device and the other communications device acting as a relay node by forming a second packet data protocol entity in the communications device and a peer second packet data protocol entity in the communications device acting as a relay node, wherein the maintaining the communications session comprises
maintaining the first packet data protocol entity for communicating data packets to the peer first packet data protocol entity in the infrastructure equipment, and
encapsulating data packets of the first packet data protocol entity as data packets for communication via the second packet data protocol entity to the second peer packet data protocol entity in the other communications device acting as a relay node.

Paragraph 25. A method according to paragraph wherein the maintaining the communications session includes
receiving an indication that the communications device should handover from the infrastructure equipment to another communications device acting as a relay node as a result of the communications device moving out of a radio coverage area of the infrastructure equipment, the other communications device being within the radio coverage area of the infrastructure equipment.

Paragraph 26. A method of paragraph 24 or 25, wherein the establishing the second packet data protocol entity and a peer second packet data protocol entity in the second communications device acting as a relay node includes maintaining end-to-end encryption or one or more other communications aspects of the communications session even though the communications device is communicating via a relay node.

Paragraph 27. A method of operating an infrastructure equipment forming part of a wireless communications network comprising a first communications device and a second communications device, the infrastructure equipment being configured to communicate with the first communications device via a first wireless access interface implemented by a first set of protocol entities in the first communications device and a corresponding first set of peer entities the infrastructure equipment, the method comprising:
configuring, for the first communications device, an indication of a configuration of a second wireless access interface to be configured for communication between the first communications device and the second communications device, the second wireless access interface being implemented by a second set of protocol entities in the first communications device and a corresponding second set of peer entities in the second communications device;
transmitting, to the first communications device, the indication of the configuration of the second wireless access interface to be configured for communication between the first communications device and the second communications device
maintaining at least one of the corresponding first set of peer protocol entities in the infrastructure equipment;
processing data using either
at least one of the maintained protocol entities of the corresponding first set of peer protocol entities in the infrastructure equipment if the data is intended for the first communications device, or
at least one of a third set of protocol entities in the infrastructure equipment if the data is intended for the second communications device to facilitate routing of the data between the first communications device, the second communications device and the infrastructure equipment, the third set of protocol entities implementing a third wireless access interface between the infrastructure equipment and the second communications device with a corresponding third set of peer protocol entities in the second communications device.

Paragraph 28. A method according to paragraph 27, wherein processing the data comprises encrypting the data.

Paragraph 29. A method according to paragraph 27, wherein maintaining the at least one protocol entity of the corresponding first set of peer protocol entities in the infrastructure equipment comprises
maintaining a first Packet Data Convergence Protocol Entity (PDCP) of the corresponding first set of peer protocol entities in the infrastructure equipment to maintain end-to-end security between the first communications device and the infrastructure equipment.

Paragraph 30. A method according to any of paragraphs 27 to 29, wherein one or more of a MAC entity, RLC entity and PHY entity of the corresponding first set of peer protocol entities in the infrastructure equipment is suspended or released.

Paragraph 31. A method according to any of paragraphs 27 to 30, comprising receiving, from the second communications device, an indication that the second communications device intends to be used as a relay between the first communications device and the infrastructure equipment.

Paragraph 32. A method according to any of paragraphs 27 to 31, comprising configuring, for the second communications device, a set of relay characteristics.

Paragraph 33. A method according to any of paragraphs 27 to 32, comprising receiving, from the first communications device, a measurement report including at least an identification of the second communications device.

Paragraph 34. A method according to paragraph 33, wherein the measurement report includes measurements of the second communications device including a reference signal received power (RSRP) of the second communications device.

Paragraph 35. A method according to any of paragraphs 27 to 32, wherein the indication of the configuration of the second wireless access interface for communication between the first communications device and the second communications device is generated in a Radio Resource Control (RRC) entity of the corresponding first set of peer protocol entities in the infrastructure equipment.

Paragraph 36. A method according to paragraph 29, wherein PDCP of the corresponding first set of peer protocol entities in the infrastructure equipment encrypts the data to generate the processed data.

Paragraph 37. A method according to any of paragraphs 27 to 36, comprising
receiving, from the second communications device via the third wireless access interface, an indication that the configuration of the second wireless access interface for communication between the first communications device and the second communications device is completed.

Paragraph 38. A method of operating a second communications device forming part of a wireless communications network comprising a first communications device and an infrastructure equipment, the method comprising
receiving, from the infrastructure equipment, an indication of a configuration of a second wireless access interface for communication between the first communications device and the second communications device, the indication of the second wireless access interface being related to a first wireless access interface for communication between the first communications device and the infrastructure equipment, the second wireless access interface being implemented by a second set of protocol entities in the first communications device and a corresponding second set of peer protocol entities in the second communications device, which correspond to a first set of protocol entities in the first communications device and a corresponding first set of peer protocol entitles in the infrastructure equipment implementing the first wireless access interface;
transmitting, to the first communications device, the indication of the configuration of the second wireless interface; and
receiving processed data from one of the first communications device or the infrastructure equipment for communicating to the other of the remote communications device or the infrastructure equipment.

Paragraph 39. A method according to paragraph 38, wherein the processed data includes encrypted data.

Paragraph 40. A method according to paragraphs 38 or 39, comprising,
determining that the processed data was received from the first communications device;
determining whether the processed data received from the first communications device was processed using either
at least one maintained protocol entity of the first set of protocol entities in the first communications device, or
at least one of the second set of protocol entities in the first communications device if the data is intended for the second communications device, and
transmitting the processed data on to the infrastructure equipment if it is determined that the processed data was processed using at least one of the maintained protocol entities of the first set of protocol entities in the first communications device, or
extracting data from the processed data if it is determined that the processed data was processed using at least one of the second set of protocol entitles in the first communications device.

Paragraph 41. A method according to paragraph 40, wherein the extracting the data comprises decrypting the encrypted data.

Paragraph 42. A method according to paragraph 40 or 41, wherein the second communications device uses a marker assigned to the processed data by an RLC entity of the second set of protocol entities in the first communications device to identify whether the data was generated in an RRC entity of the maintained protocol entities of the first set of protocol entities in the first communications device or whether the data was generated in an RRC entity of the second set of protocol entities in the first communications device to facilitate routing of the data between the first communications device, the second communications device and the infrastructure equipment.

Paragraph 43. A method according to paragraph 40 or 41, wherein the corresponding second set of peer protocol entities in the second communications device includes a Backhaul Adaptation Protocol (BAP) entity which is used to identify whether the data was generated in an RRC entity of the maintained protocol entities of the first set of protocol entities in the first communications device or whether the data was generated in an RRC entity of the second set of protocol entities in the first communications device.

Paragraph 44. A method according to paragraph 38 or 39, comprising,
determining that the processed data was received from the infrastructure equipment;
determining whether the processed data received from the infrastructure equipment was processed using either
at least one maintained protocol entity correspond to one the first set of protocol entities in the infrastructure equipment, or
at least one of a third set of protocol entities in the infrastructure equipment if the data is intended for the second communications device, and
transmitting the processed data on to the first communications device if it is determined that the processed data was processed using at least one of the maintained protocol entities in the infrastructure equipment or
extracting data from the processed data if it is determined that the processed data was processed using at least one of the third set of protocol entitles in the infrastructure equipment

Paragraph 45. A method according to paragraph 44, wherein the processed data is encrypted data and the extracting the processed data comprises decrypting the encrypted data.

Paragraph 46. A method according to paragraph 44, comprising determining whether the processed data is user plane data or control plane data in order to select an RLC channel for communication with the infrastructure equipment. Paragraph 47. A method according to any of paragraphs 44, 45 or 46, wherein the second communications device uses a marker assigned to the processed data by an RLC entity of the third set of protocol entities in the infrastructure equipment to identify whether the data was generated in an RRC entity of the maintained protocol entities of the corresponding first set of peer protocol entities in the infrastructure equipment or whether the data was generated in an RRC entity of the third set of protocol entities in the infrastructure equipment.

Paragraph 48. A method according to any of paragraphs 44, 45 or 46, wherein the second communications device assigns a marker to the processed data using an RLC entity of the corresponding second set of peer protocol entities to identify whether the data was generated in an RRC entity of the maintained protocol entities of the corresponding first set of peer protocol entities in the infrastructure equipment or whether the data was generated in an RRC entity of the third set of protocol entities in the infrastructure equipment

Paragraph 49. A method according to paragraph 44, 45 or 46, wherein the third set of protocol entities in the infrastructure equipment includes a Backhaul Adaptation Protocol (BAP) entity which is used to identify whether the data was generated in an RRC entity of the maintained protocol entities of the corresponding first set of peer protocol entities in or infrastructure equipment whether the data was generated in an RRC entity of third set of protocol entities in the infrastructure equipment.

Paragraph 50. A communications device for communicating in a wireless communications network, the communications device comprising
receiver circuitry configured to receive signals transmitted via a first wireless access interface between the communications device and an infrastructure equipment of the wireless communications network and to receive signals transmitted via a second wireless access interface between the communications device and another communications device acting as a relay for the communications device,
transmitter circuitry configured to transmit signals via the first wireless access interface between the communications device and the infrastructure equipment of the wireless communications network and to transmit signals via the second wireless access interface between the communications device and relay communications device, and controller circuity configured to control the receiver circuitry
to receive, from the infrastructure equipment, an indication of a configuration of the second wireless access interface implemented by a second set of protocol entities in the communications device and a corresponding second set of peer protocol entities in the relay communications device, which correspond to a first set of protocol entities in the first communications device and a corresponding first set of peer protocol entitles in the infrastructure equipment implementing the first wireless access interface; and
to maintain at least one (506d, 606f) of the first set of protocol entities in the first communications device;
to configure, on a basis of the indication of the configuration of the second wireless access interface received from the infrastructure equipment, the second wireless access interface for communication between the communications device and the relay communications device;
to process data using either
at least one of the maintained protocol entities of the first set of protocol entities in the communications device if the data is intended for the infrastructure equipment, or
at least one of the second set of protocol entities in the communications device if the data is intended for the relay communications device to facilitate routing of the data between the communications device, the relay communications device and the infrastructure equipment.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.

[2] RP-161901, “Revised work item proposal: Enhancements of NB-IoT”, Huawei, HiSilicon, 3GPP TSG RAN Meeting #73, New Orleans, USA, Sep. 19-22, 2016.

[3] TS 36.300, “Evolved Universal Terrestrial Radio Access (E-UTRA) and Evolved Universal Terrestrial Radio Access Network (E-UTRAN); Overall description; Stage 2 (Release 16, v16.0.0)”, 3GPP, January 2020.

1. A method of operating a first communications device (93) forming part of a wireless communications network comprising a second communications device (82) and an infrastructure equipment, the method comprising
communicating via the infrastructure equipment using a first wireless access interface implemented by a first set of protocol entities in the first communications device and a corresponding first set of peer protocol entities in the infrastructure equipment
receiving, from the infrastructure equipment, an indication of a configuration of a second wireless access interface for communication between the first communications device and the second communications device, the second wireless access interface being implemented by a second set of protocol entities in the first communications device and a corresponding second set of peer protocol entities in the second communications device;
maintaining at least one of the first set of protocol entities in the first communications device;
configuring, on a basis of the indication of the configuration of the second wireless access interface received from the infrastructure equipment, the second wireless access interface for communication between the first communications device and the second communications device;
processing data using either
at least one of the maintained protocol entities of the first set of protocol entities in the first communications device if the data is intended for the infrastructure equipment, or
at least one of the second set of protocol entities in the first communications device if the data is intended for the second communications device to facilitate routing of the data between the first communications device, the second communications device and the infrastructure equipment.

2. A method according to claim 1, comprising
transmitting the processed data intended for the infrastructure equipment to the second communications device for forwarding on to the infrastructure equipment.

3. A method according to claim 1, wherein the processing the data comprises encrypting the data.

4. A method according to claim 1, wherein maintaining the at least one protocol entity of the first set of protocol entities in the first communications device comprises
maintaining a first Packet Data Convergence Protocol Entity (PDCP) of the first set of protocol entities in the first communications device to maintain end-to-end security between the first communications device and the infrastructure equipment.

5. A method according to claim 4, wherein one or more of a MAC entity, RLC entity and PHY entity of the first set of protocol entities in the first communications device is suspended or released.

6. A method according to claim 5, wherein the maintained PDCP entity of the first set of protocol entitles in the first communications device submits the processed data to a Radio Link Control (RLC) entity of the second set of protocol entities in the first communications device if the data is intended for the infrastructure equipment.

7. A method according to claim 5, wherein a PDCP entity of the second set of protocol entitles in the first communications device submits the processed data to a Radio Link Control (RLC) entity of the second set of protocol entities in the first communications device if the data is intended for the second communications device.

8. A method according to claim 7, wherein the RLC entity of the second set of protocol entities in the first communications device assigns a marker to the processed data to identify whether the data was generated in an RRC entity of the maintained protocol entities of the first set of protocol entities in the first communications device or whether the data was generated in an RRC entity of the second set of protocol entities in the first communications device to facilitate routing of the data between the first communications device, the second communications device and the infrastructure equipment.

9. A method according to claim 8, wherein the second set of protocol entities in the first communications device includes a Backhaul Adaptation Protocol (BAP) entity which is used to identify whether the data was generated in an RRC entity of the maintained protocol entities of the first set of protocol entities in the first communications device or whether the data was generated in an RRC entity of the second set of protocol entities in the first communications device.

10. A method according to claim 9, comprising
receiving, from the second communications device, an indication that the second communications device can act as a relay between the first communications device and the infrastructure equipment

11. A method according to claim 10, wherein the indication that the second communications device can act as a relay between the first communications device and the infrastructure equipment is included in a discovery signal.

12. A method according to claim 10, wherein the indication that the second communications device can act as a relay between the first communications device and the infrastructure equipment is included in a system information block (SIB).

13. A method according to claim 12 , wherein the wireless communications network comprises one or more other communications devices which do cannot act as a relay between the first communications device and the infrastructure equipment, and the first communications device uses the indication that the second communications device can act as a relay between the first communications device and the infrastructure equipment to prioritise the configuring of the second wireless access interface for communication between the first communications device and the second communications device over a configuring of a wireless access interface for communication with the one or more other communications devices.

14. A method according to claim 13, comprising determining that the first communications device should handover to the second communications device.

15. A method according to claim 14, wherein the determining that the first communications device should handover to the second communications device is based on a signal received from the infrastructure equipment.

16. A method according to claim 14, wherein the determining that the first communications device should handover to the second communications device is based pre-defined conditions.

17. A method according to claim 16, comprising
transmitting, to the infrastructure equipment, a measurement report including at least an identification of the second communications device.

18. A method according to claim 17, wherein the measurement report includes measurements of reference signal received power (RSRP) of the second communications device.

19.-49. (canceled)

50. A communications device for communicating in a wireless communications network, the communications device comprising
receiver circuitry configured to receive signals transmitted via a first wireless access interface between the communications device and an infrastructure equipment of the wireless communications network and to receive signals transmitted via a second wireless access interface between the communications device and another communications device acting as a relay for the communications device,
transmitter circuitry configured to transmit signals via the first wireless access interface between the communications device and the infrastructure equipment of the wireless communications network and to transmit signals via the second wireless access interface between the communications device and relay communications device, and controller circuity configured to control the receiver circuitry
to receive, from the infrastructure equipment, an indication of a configuration of the second wireless access interface implemented by a second set of protocol entities in the communications device and a corresponding second set of peer protocol entities in the relay communications device, which correspond to a first set of protocol entities in the first communications device and a corresponding first set of peer protocol entitles in the infrastructure equipment implementing the first wireless access interface; and
to maintain at least one of the first set of protocol entities in the first communications device;
to configure, on a basis of the indication of the configuration of the second wireless access interface received from the infrastructure equipment, the second wireless access interface for communication between the communications device and the relay communications device;
to process data using either
at least one of the maintained protocol entities of the first set of protocol entities in the communications device if the data is intended for the infrastructure equipment, or
at least one of the second set of protocol entities in the communications device if the data is intended for the relay communications device to facilitate routing of the data between the communications device, the relay communications device and the infrastructure equipment.

51. A communications device for forming a relay communications device to a remote communications device in a wireless communications network, the communications device comprising
receiver circuitry configured to receive signals transmitted via a first wireless access interface from an infrastructure equipment of the wireless communications network and to receive signals transmitted via a second wireless access interface from the remote communications device,
transmitter circuitry configured to transmit signals via the first wireless access interface to the infrastructure equipment of the wireless communications network and to transmit signals via the second wireless access interface to the remote communications device, and controller circuity configured to control the receiver circuitry
to receive, from the infrastructure equipment, an indication of a configuration of the second wireless access interface for communication between the remote communications device and the relay communications device, the indication of the second wireless access interface being related to the first wireless access interface, the second wireless access interface being implemented by a second set of protocol entities in the remote communications device and a corresponding second set of peer protocol entities in the relay communications device, which correspond to a first set of protocol entities in the remote communications device and a corresponding first set of peer protocol entitles in the infrastructure equipment; and to control the transmitter circuitry
to transmit, to the remote communications device, the indication of the configuration of the second wireless interface;
to receive processed data from either the remote communications device or the infrastructure equipment.
